(19) United States
(12) Patent Application Publication
(10) Pub. No.: US 2018/0307762 A1
(43) Pub. Date: Oct. 25, 2018

(54) SOCIAL-BASED MANAGEMENT OF CONTENT

(71) Applicant: Sony Interactive Entertainment LLC, San Mateo, CA (US)

(72) Inventors: Kohichi Aoki, San Mateo, CA (US); Sneha Singh, San Mateo, CA (US); Katsuya Hyodo, San Mateo, CA (US); Yumi Kataoka, San Mateo, CA (US); You Asakura, San Mateo, CA (US); Daniel Morales, San Mateo, CA (US)

(21) Appl. No.: 15/491,855

(22) Filed: Apr. 19, 2017

(51) Int. Cl. G06F 17/30; G06Q 50/00

(52) U.S. Cl. CPC G06F 17/30867; G06Q 50/01; G06F 17/30554

(57) ABSTRACT

Systems and methods for social-based management of content are provided. Information regarding a plurality of users may be stored. The stored information for each user may include include a library of content titles available to the user and one or more other users identified as social contacts. A library of content available to a social contact may include at least one content title in common with the library available to the user. Activity of each social contact may be tracked in relation to the respective library available to the social contact. The library of content titles available to the user may then be filtered based on the tracked activity of the social contacts. A customized display may be generated to include content titles selected from the library available to the user based on the filter results.

### BACKGROUND

### 1. Field of the Invention

The present technology pertains to content management, and more specifically to social-based management of content.

### 2. Description of the Related Art

Presently available methods of managing content are generally based on characteristics specific to the content, such as title, author/developer, genre, date of release, etc. Furthermore, such content may be organized and presented to a user based on such characteristics (e.g., alphabetically by title).

A user experience of certain content may depend, however, on social characteristics. User enjoyment of such content may be enhanced by experiencing it with friends. Multiplayer games, for example, may require the participation of multiple players, and the experience of a particular user may be more enjoyable when the other players participating are friends. In some instances, a user decision to play content may be driven more by a desire to socialize than by the specific title.

Users may further own or have subscriptions to a large library of content. In order to search through such content, the user may do a search for various characteristics of the content title as described above. Although the user may designated a list of favorites, such a list is dependent on the user keeping it up-to-date. There is presently no way to discover new content, rediscover content, or determine what content is being played by one's friends other than by reaching out and asking such friends.

There is, therefore, a need in the art for systems and methods of social-based management of content.

### SUMMARY OF THE PRESENTLY CLAIMED INVENTION

Embodiments of the present invention include systems and methods for social-based management of content. The stored information for each user may include a library of content titles available to the user and one or more other users identified as social contacts. A library of content available to a social contact may include at least one content title in common with the library available to the user. Activity of each social contact may be tracked in relation to the respective library available to the social contact. The library of content titles available to the user may then be filtered based on the tracked activity of the social contacts. A customized display may be generated to include content titles selected from the library available to the user based on the filter results.

Various embodiments may include systems for social-based management of content. Such systems may include memory that stores for each user a library of content titles available to the user and social contacts having a library with at least one content title in common with the library available to the user, a network interface that receives information regarding tracked activity of each of the social contacts in relation to the respective library available to the social contact, and a processor that executes instructions to filter the library of content titles available to the user based on the tracked activity of the social contacts of the user and generate a customized display of content titles selected from the library available to the user based on the contact-based filter results.

Additional embodiments may include methods for social-based management of content. Such methods may include storing in memory for each user a library of content titles available to the user and social contacts having a library with at least one content title in common with the library available to the user, tracking activity of each of the social contacts in relation to the respective library available to the social contact, filtering the library of content titles available to the user based on the tracked activity of the social contacts of the user, and generating a customized display of content titles selected from the library based on the filter results.

Further embodiments include non-transitory computer-readable storage media having embodied thereon a program executable by a processor to perform a method for social-based management of content as described above.

### BRIEF DESCRIPTION OF THE DRAWINGS

FIG. 1 illustrates a network environment in which a system for social-based management of content may be implemented.

FIG. 2A is an exemplary screenshot of a customized display generated in a system for social-based management of content.

FIG. 2B is an exemplary screenshot of another customized display generated in a system for social-based management of content.

FIG. 3 is a flowchart illustrating an exemplary method for social-based management of content.

FIG. 4 is an exemplary electronic entertainment system that may be used in social-based management of content.

### DETAILED DESCRIPTION

Embodiments of the present invention include systems and methods for social-based management of content. A media title may be streamed to a producer computing device over a communication network. The producer computing device is associated with a channel for distributing the user-produced content in conjunction with the media title. Produced content may be captured from the producer computing device as the streamed media title is played on the producer computing device. Such captured produced content may be designated for the channel. The media title and the produced content may then be broadcast in real-time over the communication network to one or more subscriber devices subscribed to the channel. The media title and the produced content may be synchronized within the broadcast to reflect when the produced content was captured in relation to the media title as the media title was played on the producer computing device.

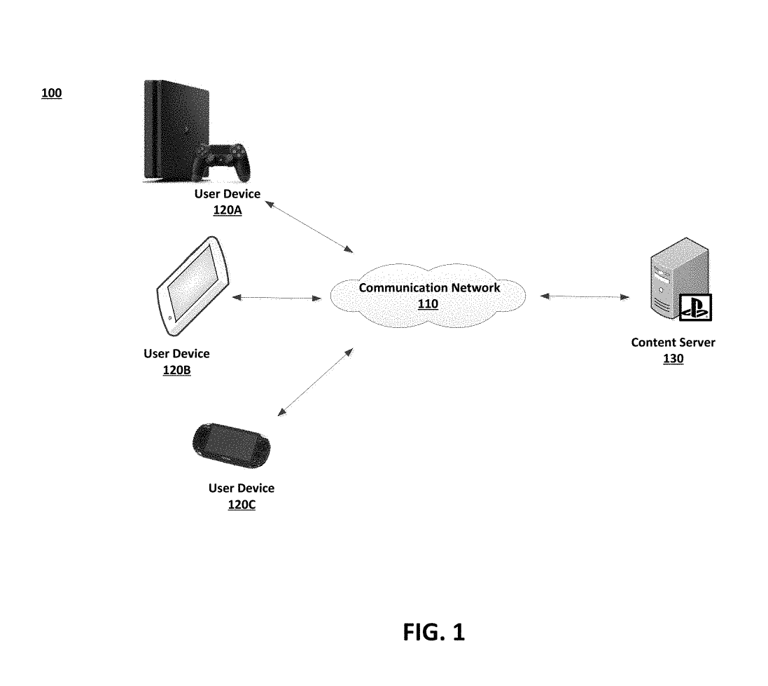

FIG. 1 illustrates a network environment 100 in which a system for social-based management of content may be implemented. The network environment 100 may include a communication network 110 through which one or more client devices 120A-C may communicate with content server 130.

Communication network 110 is preferably a local, proprietary network (e.g., an intranet) and/or is alternatively a part of a larger wide-area network (e.g., the cloud). Communications network 110 can be a local area network (LAN), which is communicatively coupled to a wide area network (WAN) such as the Internet. The Internet is a broad network of interconnected computers and servers allowing for the transmission and exchange of Internet Protocol (IP) data between users connected through a network service provider. Examples of network service providers are the public switched telephone network, a cable service provider, a provider of digital subscriber line (DSL) services, or a satellite service provider. Communications network 110 allows for communication between the various components of network environment 100.

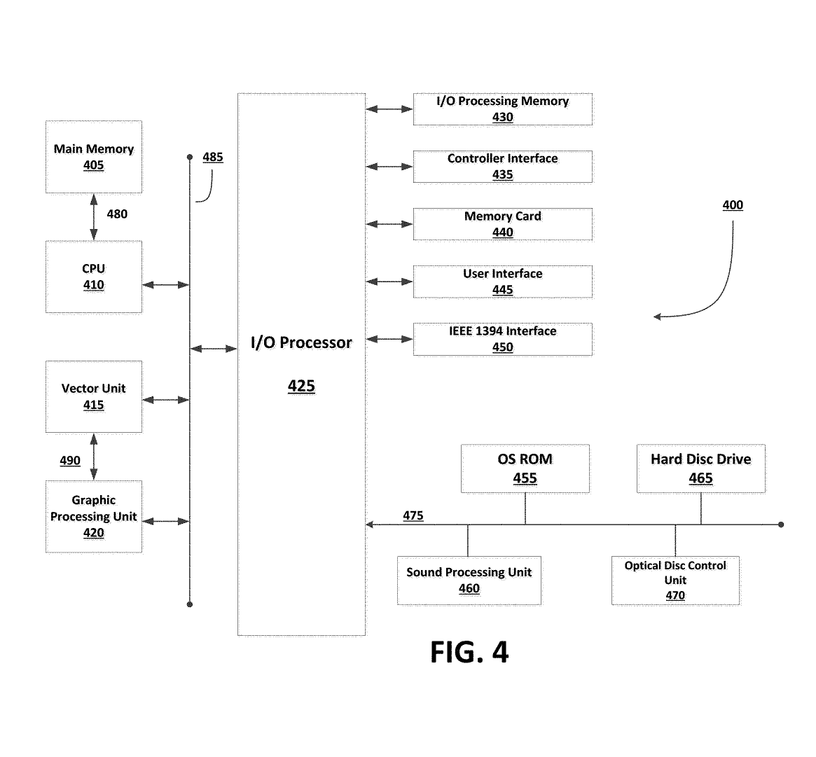

Users may use any number of different electronic computing devices 120A-C, which can include, but is not limited to, general purpose computers, mobile phones, smartphones, personal digital assistants (PDAs), portable computing devices (e.g., laptop, netbook, tablets), desktop computing devices, handheld computing devices, tablet devices, game consoles, smart televisions, or any other type of computing device capable of communicating over communication network 110. Such devices 120A-C are preferably configured to access data from other storage media, such as, but not limited to memory cards or disk drives as may be appropriate in the case of downloaded services. Such devices 120A-C preferably include standard hardware computing components such as, but not limited to network and media interfaces, non-transitory computer-readable storage (memory), and processors for executing instructions that may be stored in memory. An exemplary computing device 120 is further illustrated and described with respect to FIG. 4.

Content server 130 may include any type of server or other computing device as is known in the art, including standard hardware computing components such as network and media interfaces, non-transitory computer-readable storage (memory), and processors for executing instructions or accessing information that may be stored in memory. The functionalities of multiple servers may be integrated into a single server. Any of the aforementioned servers (or an integrated server) may take on certain client-side, cache, or proxy server characteristics. These characteristics may depend on the particular network placement of the server or certain configurations of the server.

Content server 130 may host a variety of digital media content available to user devices 120 in the network environment 100. Each user (e.g., of user device 120) may be associated with an account that allows the user to access a library of content. Some of the content may be free, while others require purchase or subscription. As such, content server 130 may store a profile for each user that includes information specific to the user, including user name, a listing of content titles that are available to the user, user activity with respect to each content title, etc.

In addition, content server 130 may further store information regarding social contacts of the user. Such social contacts, who are also users within the network environment 100, may be designated by the user as such. In some embodiments, the user may further characterize the social contact by degree of familiarity, types of shared activities, types of content in common, common interests, defined teams or clans (which may or may not be specific to a title), or any other category.

Because content server 130 hosts the content, content server 130 may monitor a variety of user activity involving such content in real-time. Such activity may include a new purchase or subscription, each time a content title is played, how long the content title is played, certain milestones reached with respect to a content title (e.g., points, levels, trophies, achievements, etc.), pre-orders, etc. Using such tracked information regarding the social contacts of a particular user, content server 130 may filter the user library to identify which content titles are associated with, inter alia, the most activity among the social contacts. For example, content server 130 may identify that three friends are currently playing “Call of Duty: Black Ops,” another friend is playing “NBA2K17,” and yet another friend is playing “Driveclub.”

The content server 130 may then filter the user library based on such tracked activity. Using the above example, the content server 130 may identify that “Call of Duty: Black Ops” and “NBA2K17” appear in the user library, while “Driveclub” does appear in the user library. A customized content display may then be generated to display a selected set of content title to the user. Such content tiles may be selected from the user library and presented based on the tracked activity of the social contacts. In some embodiments, the order of presentation may be based on various weighting factors, including number of contacts currently playing the title, how recently past play occurred, category of the social contact playing the title, amount of activity related to the title, etc.

In some embodiments, related content titles may be considered to be in common between the user library and a contact library. For example, “NBA2K17” and its previous iteration “NBA2K16” may be considered a title in common if a user had one and a social contact had the other in their respective libraries. Likewise, content with similar titles, the same studio, the same developer, etc. may be considered titles in common.

In contrast to methods of filtering that are based on solely on characteristics of the content (e.g., alphabetically by title), such customized filtering is specific to the user. In particular, the customized filtering is based on the library of the user and the social contacts of the user. The result of such customized filtering allows for generation of a customized display of content titles.

Such social-based content filtering may further allow for users to discover new content enjoyed by their friends, rediscover owned content based on renewed popularity among friends, as well as create wishlists and preorders of content in which their friends are also interested. The customized content filtering may further drive social and content engagement as users may easily discover what content their friends are engaged in and join in without having to reach out individually.

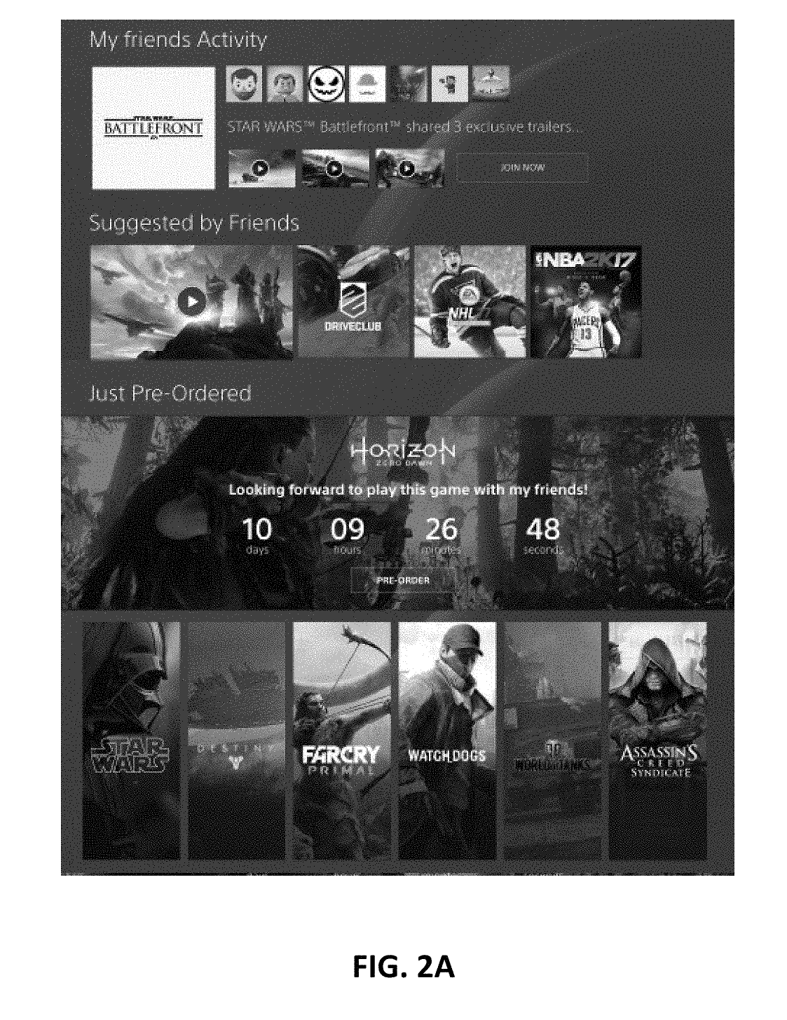

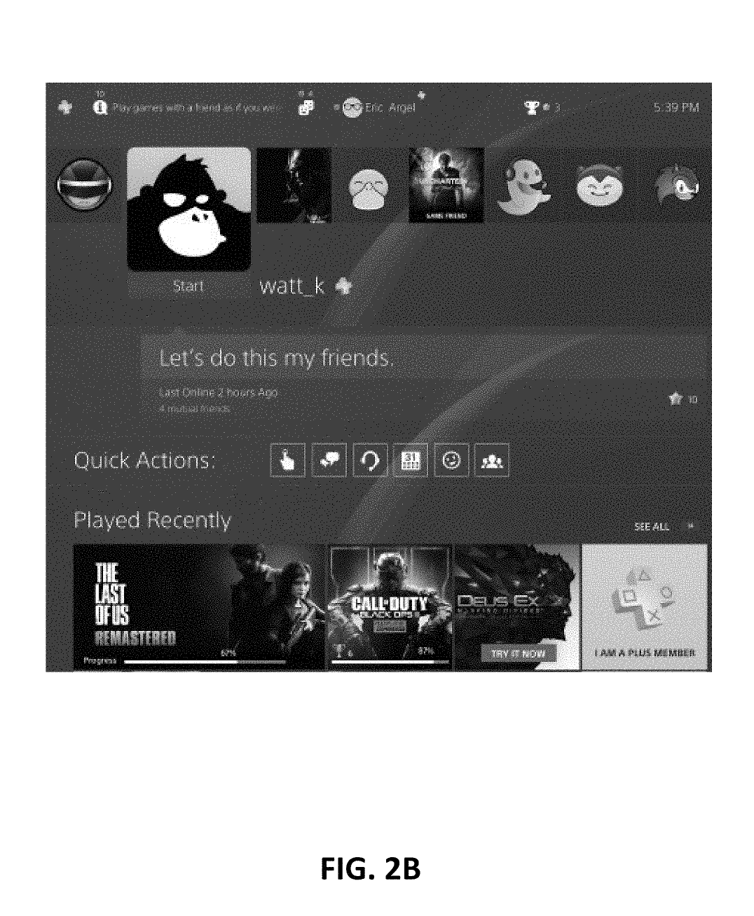

FIG. 2A is an exemplary screenshot of a customized display generated in a system for social-based management of content. As illustrated, such a customized display may include a section (“My friends' Activity”), which indicates which game is currently being played by one's friends along with related content trailers. Additional activity information may include a “Suggested by Friends” section and a “Just Pre-Ordered” section.

FIG. 2B is an exemplary screenshot of another customized display generated in a system for social-based management of content. As illustrated, a toolbar comprising icons representative of a number of friends may be included, as well as a “Played Recently” section. From the toolbar, the user may drill down to the profile of the specific social contact, which may further indicate such details as whether the contact is currently logged into the network, currently active, in what game the contact is active, recent games played, and other activity information. Each user may set privacy controls, however, to control what their friends or other social contacts may view within their respective profiles.

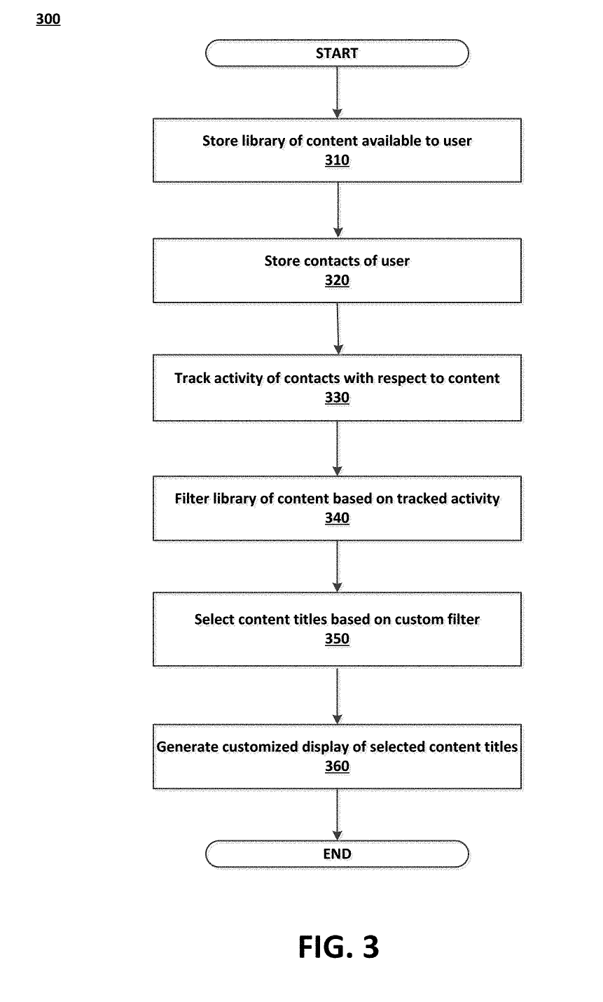

FIG. 3 is a flowchart illustrating an exemplary method 200 for social-based management of content. The method 300 of FIG. 2 may be embodied as executable instructions in a non-transitory computer readable storage medium including but not limited to a CD, DVD, or non-volatile memory such as a hard drive. The instructions of the storage medium may be executed by a processor (or processors) to cause various hardware components of a computing device hosting or otherwise accessing the storage medium to effectuate the method. The steps identified in FIG. 3 (and the order thereof) are exemplary and may include various alternatives, equivalents, or derivations thereof including but not limited to the order of execution of the same.

In method 200, information may be stored regarding a user, including a library of content titles available to that user and a set of social contacts of the user. Information may be tracked regarding social content activity with respect to the one or more content titles, and the user library may be filtered based on the tracked activity. One or more content titles from the user library may be selected based on the custom filter, and the customized display may be generated to feature the selected content titles.

In step 310, information may be stored in memory regarding a library of content titles available to the user. Such content titles may have been previously purchased or subscribed-to and may further include free content selected by the user for inclusion in his or her library. In some embodiments, the content titles may be given to the user as a gift by others. Such content information may be stored at content server 130 or in an associated database.

In step 320, information may be stored in memory regarding contacts of the user. Such contacts may have been designated by the user, imported from another database, or based on activity (e.g., membership in a team within a game). In addition, each social contact may be grouped or characterized by the user. Such contact information may be stored at content server 130 or in an associated database.

In step 330, activity of the social contacts that involve content may be tracked by content server 130. As indicated above, such activity may include pre-ordering a content title, purchase or otherwise obtaining a content title, starting play of a content title, progress of the play, stopping play, etc.

In step 340, the user library of content may be filtered based on the tracked activity of their contacts. Various weights may be assigned based on a number of contacts interacting with a content title, extent of activity, related content titles, and other parameters regarding the contacts and their activity.

In step 350, a set of content titles may be selected based on the filter results, and in step 360, a customized display of the selected content titles may be generated. Such a customized display may appear similar to the displays of FIGS. 2A and 2B. In such a customized display, a user library is presented to the user based on various content-related activities by the contacts of the user. Such a display may be generated in real-time as the tracked activity occurs and/or may be refreshed periodically to reflect current activity.

FIG. 4 is an exemplary electronic entertainment system that may be used in real-time incorporation of user-produced media into a broadcast media stream. The entertainment system 400 of FIG. 4 includes a main memory 405, a central processing unit (CPU) 410, vector unit 415, a graphics processing unit 420, an input/output (I/O) processor 425, an I/O processor memory 430, a controller interface 435, a memory card 440, a Universal Serial Bus (USB) interface 445, and an IEEE 1394 interface 450. The entertainment system 400 further includes an operating system read-only memory (OS ROM) 455, a sound processing unit 460, an optical disc control unit 470, and a hard disc drive 465, which are connected via a bus 475 to the I/O processor 425.

Entertainment system 400 may be an electronic game console. Alternatively, the entertainment system 400 may be implemented as a general-purpose computer, a set-top box, a hand-held game device, a tablet computing device, or a mobile computing device or phone. Entertainment systems may contain more or less operating components depending on a particular form factor, purpose, or design.

The CPU 410, the vector unit 415, the graphics processing unit 420, and the I/O processor 425 of FIG. 4 communicate via a system bus 485. Further, the CPU 410 of FIG. 4 communicates with the main memory 405 via a dedicated bus 480, while the vector unit 415 and the graphics processing unit 420 may communicate through a dedicated bus 490. The CPU 410 of FIG. 4 executes programs stored in the OS ROM 455 and the main memory 405. The main memory 405 of FIG. 4 may contain pre-stored programs and programs transferred through the I/O Processor 425 from a CD-ROM, DVD-ROM, or other optical disc (not shown) using the optical disc control unit 470. I/O Processor 425 of FIG. 4 may also allow for the introduction of content transferred over a wireless or other communications network (e.g., 4$, LTE, 1G, and so forth). The I/O processor 425 of FIG. 4 primarily controls data exchanges between the various devices of the entertainment system 400 including the CPU 410, the vector unit 415, the graphics processing unit 420, and the controller interface 435.

The graphics processing unit 420 of FIG. 4 executes graphics instructions received from the CPU 410 and the vector unit 415 to produce images for display on a display device (not shown). For example, the vector unit 415 of FIG. 4 may transform objects from three-dimensional coordinates to two-dimensional coordinates, and send the two-dimensional coordinates to the graphics processing unit 420. Furthermore, the sound processing unit 460 executes instructions to produce sound signals that are outputted to an audio device such as speakers (not shown). Other devices may be connected to the entertainment system 400 via the USB interface 445, and the IEEE 1394 interface 450 such as wireless transceivers, which may also be embedded in the system 400 or as a part of some other component such as a processor.

A user of the entertainment system 400 of FIG. 4 provides instructions via the controller interface 435 to the CPU 410. For example, the user may instruct the CPU 410 to store certain game information on the memory card 440 or other non-transitory computer-readable storage media or instruct a character in a game to perform some specified action.

The present invention may be implemented in an application that may be operable by a variety of end user devices. For example, an end user device may be a personal computer, a home entertainment system (e.g., Sony PlayStation2® or Sony PlayStation3® or Sony PlayStation4®), a portable gaming device (e.g., Sony PSP® or Sony Vita®), or a home entertainment system of a different albeit inferior manufacturer. The present methodologies described herein are fully intended to be operable on a variety of devices. The present invention may also be implemented with cross-title neutrality wherein an embodiment of the present system may be utilized across a variety of titles from various publishers.

Non-transitory computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of non-transitory computer-readable media include, for example, a floppy disk, a flexible disk, a hard disk, magnetic tape, any other magnetic medium, a CD-ROM disk, digital video disk (DVD), any other optical medium, RAM, PROM, EPROM, a FLASHEPROM, and any other memory chip or cartridge.

Various forms of transmission media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU. Various forms of storage may likewise be implemented as well as the necessary network interfaces and network topologies to implement the same.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A server system for social-based management of content, the system comprising:
memory that stores information regarding a plurality of users, wherein the stored information for each user includes:
a library of content titles available to the user, and
one or more other users identified as social contacts of the user, wherein a library available to at least one of the social contacts includes at least one content title in common with the library available to the user;
a network interface that receives information regarding tracked activity of each of the social contacts in relation to the respective library available to the social contact; and
a processor that executes instructions stored in memory, wherein execution of the instructions by the processor:
filters the library of content titles available to the user based on the tracked activity of the social contacts of the user; and
generates a customized display of content titles selected from the library available to the user, wherein the content titles are selected based on the contact-based filter results.

2. The system of claim 1, wherein the at least one content title is identified as common to the library of the user when the at least one content title is related to another content title in the library available to the user.

3. The system of claim 1, wherein the tracked activity information includes an identification that at least one social contact is currently playing the common content title.

4. The system of claim 4, wherein the customized display indicates a number of social contacts who are currently playing the common content title.

5. The system of claim 1, wherein the processor filters the library by weighting the tracked activity based on how recently at least one social contact played the common content title.

6. The system of claim 1, wherein the social contacts are grouped into one or more categories, and wherein the processor filters the library by weighting the tracked activity based on at least one of the categories.

7. The system of claim 1, wherein the processor updates the customized display in real-time to reflect a detected change in the tracked activity of at least one social contact.

8. The system of claim 1, wherein the processor updates the customized display periodically to reflect any change in the tracked activity of at least one social contact within a defined time period.

9. The system of claim 1, wherein each social contact is associated with a profile accessible to the user, the profile including information regarding the tracked activity of the respective social contact.

10. A method for social-based management of content, the method comprising:
storing in memory information regarding a plurality of users, wherein the stored information for each user includes:
a library of content titles available to the user, and
one or more other users identified as social contacts of the user, wherein a library available to at least one of the social contacts includes at least one content title in common with the library available to the user;
tracking activity of each of the social contacts in relation to the respective library available to the social contact;
filtering the library of content titles available to the user based on the tracked activity of the social contacts of the user; and
generating a customized display of content titles selected from the library available to the user, wherein the content titles are selected based on the filter results.

11. The method of claim 10, wherein the at least one content title is identified as common to the library of the user when the at least one content title is related to another content title in the library available to the user.

12. The method of claim 10, wherein tracking the activity includes identifying that at least one social contact is currently playing the common content title.

13. The method of claim 12, wherein the customized menu indicates a number of social contacts who are currently playing the common content title.

14. The method of claim 10, wherein filtering the library comprises weighting the tracked activity based on how recently at least one social contact played the common content title.

15. The method of claim 10, further comprising grouping the social contacts into one or more categories, and wherein filtering the library comprises weighting the tracked activity based on at least one of the categories.

16. The method of claim 10, further comprising updating the customized display is updated in real-time to reflect a detected change in the tracked activity of at least one social contact.

17. The method of claim 10, further comprising updating the customized display periodically to reflect any change in the tracked activity of at least one social contact within a defined time period.

18. The method of claim 10, wherein each social contact is associated with a profile accessible to the user, the profile including information regarding the tracked activity of the respective social contact.

19. A non-transitory computer-readable medium having embodied thereon a program executable by a processor to perform a method for social-based management of content, the method comprising:
storing information regarding a plurality of users, wherein the stored information for each user includes:
a library of content titles available to the user, and
one or more other users identified as social contacts of the user, wherein a library available to at least one of the social contacts includes at least one content title in common with the library available to the user;
tracking activity of each of the social contacts in relation to the respective library available to the social contact;
filtering the library of content titles available to the user based on the tracked activity of the social contacts of the user; and
generating a customized display of content titles selected from the library available to the user, wherein the content titles are selected based on the filter results.
